(19) United States
(12) Patent Application Publication
(10) Pub. No.: US 2024/0067012 A1
(43) Pub. Date: Feb. 29, 2024

(54) ELECTRIC VEHICLE CHARGER WITH OPTIONAL AND CONFIGURABLE DIGITAL SIGNAGE

(71) Applicant: Meridian Kiosks, Aberdeen, NC (US)

(72) Inventors: Christopher GILDER, Aberdeen, NC (US); Ross DALLIMORE, Aberdeen, NC (US); Eric Russell FRANK, Aberdeen, NC (US); Victor GRAHAM, Aberdeen, NC (US); Joel SETCHELL, Aberdeen, NC (US); Joshua David EDWARDS, Aberdeen, NC (US)

(73) Assignee: Meridian Kiosks, Aberdeen, NC (US)

(21) Appl. No.: 17/896,605

(22) Filed: Aug. 26, 2022

(51) Int. Cl. B60L 53/30; B60L 53/18

(52) U.S. Cl. CPC B60L 53/30; B60L 53/18

(57) ABSTRACT

A hybrid electric vehicle charging station (EVCS) is provided. The EVCS includes a charging chassis that is configured to support a charging circuitry for providing a charge current to an electric vehicle and a multi-conductor cable that is attached to the charging chassis and that receives the charging current from the charging circuitry and that transmits the charging current to the electric vehicle. The EVCS further includes a user interface that is attached to the charging chassis and that is configured to provide digital content to a vehicle operator during a charging event of the electric vehicle. The charging chassis includes multiple user interface attachment structures that are each configured to support the user interface.

### BACKGROUND OF THE DISCLOSURE

As electric vehicles become more prevalent, there is an increased need for charging stations. Many of these charging stations are in public places, such as parking lots for retail areas, office buildings, and on public streets. These areas often have a large volume of vehicle and pedestrian traffic, and as such, are ideal locations for advertising. Some of these areas may also each have spatial and/or environmental configurations that may render the installation of certain types of charging stations as unworkable or sub-optimal.

### BRIEF SUMMARY OF THE DISCLOSURE

Some embodiments are directed to a hybrid electric vehicle charging station (EVCS) that includes a charging chassis that is configured to support a charging circuitry for providing a charge current to an electric vehicle, a multi-conductor cable that is attached to the charging chassis and that receives the charging current from the charging circuitry and that transmits the charging current to the electric vehicle, and a user interface that is attached to the chassis and that is configured to provide digital content to a vehicle operator during a charging event of the electric vehicle, wherein the charging chassis includes multiple of user interface attachment structures that are each configured to support the user interface.

Some embodiments herein are directed to methods that include determining environmental conditions corresponding to a user interface installation on an EVCS at a desired location, determining a quantity of user interfaces that are compatible with the environmental conditions, determining a location corresponding to each of the quantity of user interfaces, determining an orientation corresponding to each of the plurality of user interfaces, identifying multiple user interface attachment structures corresponding to the user interfaces and attaching the user interface to the location and in the orientation on the EVCS.

### BRIEF DESCRIPTION OF THE DRAWINGS

FIG. 1 illustrates a management system including a plurality of electric vehicle charging stations (EVCS) with optional and/or configurable user interfaces for enhancing user experience according to some embodiments herein.

FIG. 2 is a block diagram that illustrates various components of a computing device for enhancing experience at an EVCS, which may embody or be included as part of the devices, systems, and/or components above, according to some embodiments.

FIG. 3 is a block diagram of an example EVCS according to some embodiments.

FIGS. 4A-4H are schematic partial block diagrams illustrating hybrid EVCS embodiments disclosed herein.

FIG. 5 is a schematic partial block diagram illustrating a user interface according to some embodiments.

FIG. 6 is a flowchart illustrating operations of systems/methods according to some embodiments.

### DETAILED DESCRIPTION OF THE DISCLOSURE

Some embodiments provide that electric vehicle (EV) charging is a rapidly growing market as the needs increase the use cases are also changing. In some embodiments, an increase in customer focus towards options for charging may result in the traffic of customers spending time at charging stations to increase. With various implementations in various locations, a hybrid EV charger with the ability to have digital interactive services may provide digital interactive wayfinding and/or food ordering, among others. Such solutions may be advantageous for future retail, entertainment, and/or other services among others.

Some embodiments provide solutions that may provide the option for customers to have dedicated EV charging station (EVCS) chargers. Such embodiments may also provide the ability to add interactive displays that will allow the consumer to use for wayfinding, (electronic delivery to a consumer of a digital promotion from the EVCS owner, the ability for a 3^{rd} party, restaurant, and/or retailer to deliver a promotion via the charger to a consumer. Embodiments may include the ability to alert maintenance for service, notification of charger availability and remote charging/vehicle status. Some embodiments provide charger usage data and promotion usage data to the charger owner (e.g., retailer, restaurant). Digital sign data may be provided for food ordering, interactive digital advertising, and/or communication with payment capability, among others. A sign attachment can be orientated in different positions relative to the placement of the charger housing depending on the need of the customer and how their consumers can view and interact with the EVCS. Embodiments herein may provide the customer with the ability to have a uniform look of EV charging stations while also providing configurable interactive solutions when needed.

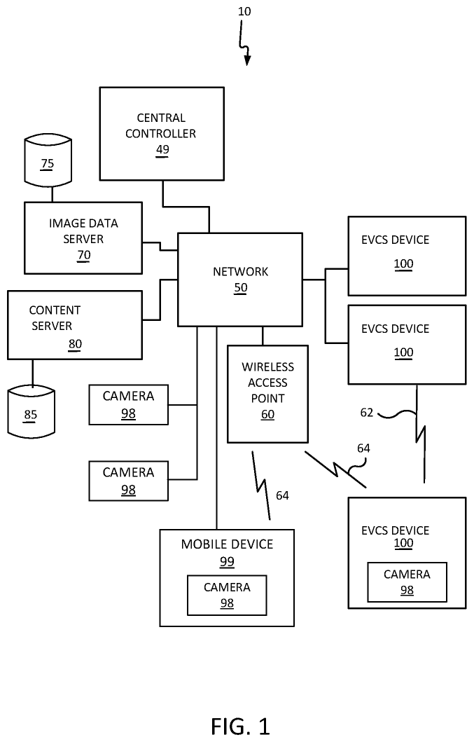

Reference is now made to FIG. 1, which illustrates a management system including a plurality of electric vehicle charging stations (EVCS) with optional and/or configurable user interfaces for enhancing user experience according to some embodiments herein.

The management system 10 may be located, for example, on the premises of a retail, food, entertainment and/or parking establishment, or may include components that are located at different locations. The EVCS devices 100 may be in communication with each other and/or a central controller 49 through a data communication network 50, or remote communication link. The data communication network 50 may be a private data communication network that is operated, for example, by the EVCS owner, a publicly accessible data communication network such as the Internet, or a combination thereof. Communications over the data communication network 50 may be encrypted for security. The central controller 49 may be any suitable server or computing device which includes at least one processor circuit, such as a processor, and at least one memory or storage device. Each EVCS device 100 may include a processor circuit that transmits and receives events, messages, commands or any other suitable data or signal between the EVCS device 100 and the central controller 49 and/or other EVCS devices 100. The EVCS device processor is operable to execute such communicated events, messages or commands in conjunction with the operation of the EVCS device 100. Moreover, the processor of the central controller 49 is configured to transmit and receive events, messages, commands or any other suitable data or signal between the central controller 49 and each of the individual EVCS devices 100. In some embodiments, one or more of the functions of the central controller 49 may be performed by one or more EVCS device processors. Moreover, in some embodiments, one or more of the functions of one or more EVCS device processors as disclosed herein may be performed by the central controller 49.

A wireless access point 60 provides wireless access to the data communication network 50. The wireless access point 60 may be connected to the data communication network 50 or may be connected directly to the central controller 49 or another server connected to the data communication network 50.

One or more content servers, such as content server 80, may also be connected through the data communication network 50. Similarly, the content server 80 may manage delivery of the content to the user of a EVCS device 100. The content may be stored in a content database 85. An image data server 70 may receive, process, manage access, update, store, make consensus determinations, and/or make determinations regarding predicted actions and/or cause casino related actions to be performed. The image and related data may be stored in an image data database 75. The image data server 70 and a content server 80 may be implemented within or separately from each other. The image data server 70 and a content server 80 may also be implemented within or separately from the central controller 49.

The EVCS devices 100 communicate with one or more elements of the system 10 to coordinate providing streaming video content and/or synchronized content. For example, in some embodiments, an EVCS device 100 may communicate directly with another EVCS device 100 over a wireless interface 62, which may be a WiFi link, a Bluetooth link, an NFC link, etc. In other embodiments, the EVCS device 100 may communicate with the data communication network 50 (and devices connected thereto, including EVCSs) over a wireless interface 64 with the wireless access point 60. The wireless interface 64 may include a WiFi link, a Bluetooth link, an NFC link, etc. In still further embodiments, the EVCS device 100 may communicate with other EVCS devices 100 or other devices over the wireless interface 62 and the wireless access point 60 over the wireless interface 64. In these embodiments, the wireless interface 62 and the wireless interface 64 may use different communication protocols and/or different communication resources, such as different frequencies, time slots, spreading codes, etc. For example, in some embodiments, the wireless interface 62 may be a Bluetooth link, while the wireless interface 64 may be a WiFi link.

The wireless interfaces 62, 64 allow the EVCS devices 100 and/or central controller 49 to coordinate providing user data from EVCS devices 100.

Embodiments may include one or more cameras 98. As used herein, a camera 98 may include a device including any type of image capture device that is configured to generate image data that may include visual signals. Embodiments herein provide that a camera 98 may be a stand-alone camera 98 and/or may be integrated into another device. For example, a camera 98 may be a component of a EVCS device 100 and/or a mobile device 99. One or more cameras 98 may be connected via the network 50 using wired and/or wireless interfaces 62, 64.

Systems herein may be configured to communicate corresponding to a specific user using a mobile device 99 that is associated with that user and that is operable to communicate over the network using wired and/or wireless interfaces 62, 64.

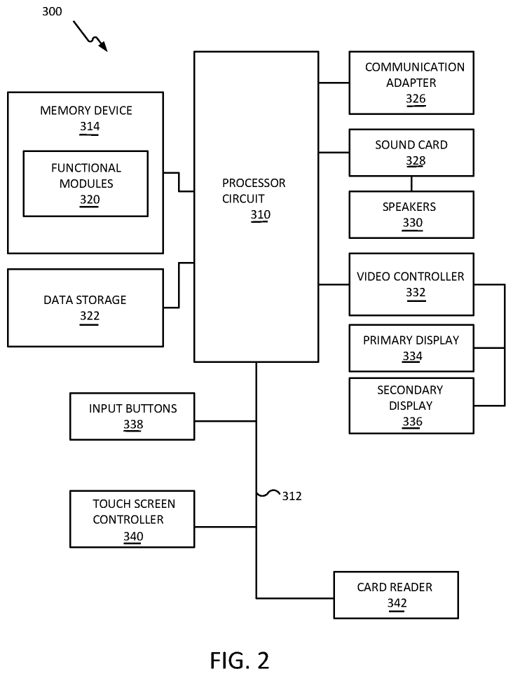

Reference is now to FIG. 2, which is a block diagram that illustrates various components of a computing device 300, which may embody or be included as part of the devices, systems, and/or components above, according to some embodiments. As shown in FIG. 2, the computing device 300 may include a processor circuit 310 that controls operations of the computing device 300. Although illustrated as a single processor, multiple special purpose and/or general-purpose processors and/or processor cores may be provided in the computing device 300. For example, the computing device 300 may include one or more of a video processor, a signal processor, a sound processor and/or a communication controller that performs one or more control functions within the computing device 300. The processor circuit 310 may be variously referred to as a “controller,” “microcontroller,” “microprocessor” or simply a “computer.” The processor circuit 310 may further include one or more application-specific integrated circuits (ASICs).

Various components of the computing device 300 are illustrated in FIG. 2 as being connected to the processor circuit 310. It will be appreciated that the components may be connected to the processor circuit 310 and/or each other through one or more buses 312 including a system bus, a communication bus and controller, such as a USB controller and USB bus, a network interface, or any other suitable type of connection.

The computing device 300 further includes a memory device 314 that stores one or more functional modules 320 for performing the operations described above. Alternatively, or in addition, some of the operations described above may be performed by other devices connected to the network, such as a network 50 illustrated in FIG. 1, for example. The computing device 300 may communicate with other devices connected to the network to facilitate performance of some of these operations. For example, the computing device 300 may communicate and coordinate with certain displays to identify elements being displayed by a particular display.

The memory device 314 may store program code and instructions, executable by the processor circuit 310, to control the computing device 300. The memory device 314 may include random access memory (RAM), which can include non-volatile RAM (NVRAM), magnetic RAM (ARAM), ferroelectric RAM (FeRAM) and other forms as commonly understood in the industry. In some embodiments, the memory device 314 may include read only memory (ROM). In some embodiments, the memory device 314 may include flash memory and/or EEPROM (electrically erasable programmable read only memory). Any other suitable magnetic, optical and/or semiconductor memory may operate in conjunction with the EVCS device disclosed herein.

The computing device 300 may include a communication adapter 326 that enables the computing device 300 to communicate with remote devices, such as the wireless network, another computing device 300, and/or a wireless access point, over a wired and/or wireless communication network, such as a local area network (LAN), wide area network (WAN), cellular communication network, or other data communication network, e.g., the network 50 of FIG. 1.

The computing device 300 may include one or more internal or external communication ports that enable the processor circuit 310 to communicate with and to operate with internal or external peripheral devices, such as a sound card 328 and speakers 330, video controllers 332, a primary display 334, a secondary display 336, input buttons 338 or other devices such as switches, keyboards, pointer devices, and/or keypads, a touch screen controller 340, a card reader 342, currency acceptors and/or dispensers, cameras, sensors such as motion sensors, mass storage devices, microphones, haptic feedback devices, and/or wireless communication devices. In some embodiments, internal or external peripheral devices may communicate with the processor through a universal serial bus (USB) hub (not shown) connected to the processor circuit 310. Although illustrated as being integrated with the computing device 300, any of the components therein may be external to the computing device 300 and may be communicatively coupled thereto. Although not illustrated, the computing device 300 may further include a rechargeable and/or replaceable power device and/or power connection to a main power supply, such as a building and/or premises power supply.

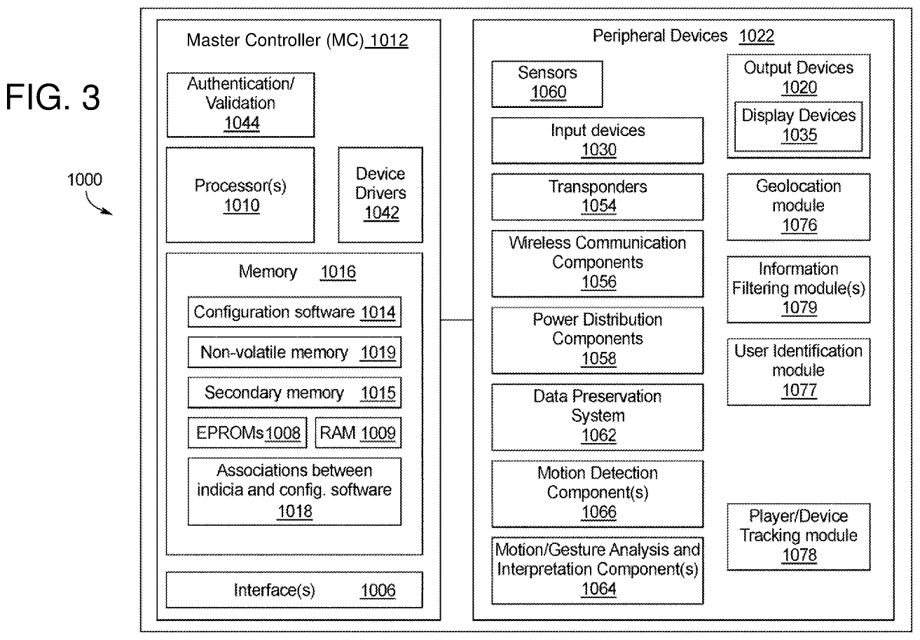

Reference is now made to FIG. 3, which is a block diagram of an example EVCS. The EVCS 1000 is merely an example EVCS and different EVCSs 1000 may be implemented using different combinations of the components shown in the EVCSs 1000. Although the below refers to EVCSs, 1000 in various embodiments, embodiments may include some or all of the below components.

In these embodiments, the EVCS 1000 includes a master controller 1012 configured to communicate with and to operate with a plurality of peripheral devices 1022.

The master controller 1012 includes at least one processor 1010. The at least one processor 1010 is any suitable processing device or set of processing devices, such as a microprocessor, a microcontroller-based platform, a suitable integrated circuit, or one or more application-specific integrated circuits (ASICs), configured to execute software enabling various configuration and reconfiguration tasks, such as: (1) communicating with a remote source (such as a server that stores authentication information or content information) via a communication interface 1006 of the master controller 1012; (2) converting signals read by an interface to a format corresponding to that used by software or memory of the EVCS; (3) accessing memory to configure or reconfigure parameters in the memory according to indicia read from the EVCS; (4) communicating with interfaces and the peripheral devices 1022 (such as input/output devices); and/or (5) controlling the peripheral devices 1022. In certain embodiments, one or more components of the master controller 1012 (such as the at least one processor 1010) reside within a housing of the EVCS 1000, while in other embodiments at least one component of the master controller 1012 resides outside of the housing of the EVCS 1000.

The master controller 1012 also includes at least one memory device 1016, which includes: (1) volatile memory (e.g., RAM 1009, which can include non-volatile RAM, magnetic RAM, ferroelectric RAM, and any other suitable forms); (2) non-volatile memory 1019 (e.g., disk memory, FLASH memory, EPROMs, EEPROMs, memristor-based non-volatile solid-state memory, etc.); (3) unalterable memory (e.g., EPROMs 1008); (4) read-only memory; and/or (5) a secondary memory storage device 1015, such as a non-volatile memory device, configured to store software related information (the software related information and the memory may be used to store various audio files and content not currently being used and invoked in a configuration or reconfiguration). Any other suitable magnetic, optical, and/or semiconductor memory may operate in conjunction with the EVCS 1000 disclosed herein. In certain embodiments, the at least one memory device 1016 resides within the housing of the EVCS 1000, while in other embodiments at least one component of the at least one memory device 1016 resides outside of the housing of the EVCS. In these embodiments, any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

The at least one memory device 1016 is configured to store, for example: (1) configuration software 1014, such as all the parameters and settings for content usable via the user interface; (2) associations 1018 between configuration indicia read from an EVCS 1000 with one or more parameters and settings; (3) communication protocols configured to enable the at least one processor 1010 to communicate with the peripheral devices 1022; and/or (4) communication transport protocols (such as TCP/IP, USB, Firewire, IEEE1394, Bluetooth, IEEE 802.11x (IEEE 802.11 standards), hiperlan/2, HomeRF, etc.) configured to enable the EVCS 1000 to communicate with local and non-local devices using such protocols. In one implementation, the master controller 1012 communicates with other devices using a serial communication protocol. A few non-limiting examples of serial communication protocols that other devices, such as peripherals (e.g., a bill validator or a ticket printer), may use to communicate with the master controller 1012 include USB, and/or RS-232, among others.

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the owner's computer, partly on the owner's computer, as a stand-alone software package, partly on the owner's computer and partly on a remote computer or entirely on the remote computer or server. In the latter scenario, the remote computer may be connected to the owner's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

In certain embodiments, the at least one memory device 1016 is configured to store program code and instructions executable by the at least one processor of the EVCS 1000 to control the EVCS 1000. The at least one memory device 1016 of the EVCS also stores other operating data, such as image data, event data, and/or input data, among others. In various embodiments, part or all of the program code and/or the operating data described above is stored in at least one detachable or removable memory device including, but not limited to, a cartridge, a disk, a CD ROM, a DVD, a USB memory device, or any other suitable non-transitory computer readable medium. In certain such embodiments, an owner and/or a user uses such a removable memory device in an EVCS 1000 to implement at least part of the present disclosure. In other embodiments, part or all of the program code and/or the operating data is downloaded to the at least one memory device of the EGM through any suitable data network described above (such as an Internet or intranet).

The at least one memory device 1016 also stores a plurality of device drivers 1042. Examples of different types of device drivers include device drivers for EVCS components and device drivers for the peripheral components 1022. Typically, the device drivers 1042 utilize various communication protocols that enable communication with a particular physical device. The device driver abstracts the hardware implementation of that device. For example, a device driver may be written for each type of card reader that could potentially be connected to the EVCS 1000. Non-limiting examples of communication protocols used to implement the device drivers include USB, Serial, Ethernet 175, Firewire, I/O debouncer, direct memory map, serial, PCI, parallel, RF, Bluetooth™, near-field communications (e.g., using near-field magnetics), 802.11 (WiFi), etc. In one embodiment, when one type of a particular device is exchanged for another type of the particular device, the at least one processor of the EVCS loads the new device driver from the at least one memory device to enable communication with the new device. For instance, one type of card reader in the EGM can be replaced with a second different type of card reader when device drivers for both card readers are stored in the at least one memory device.

In certain embodiments, the software units stored in the at least one memory device 1016 can be upgraded as needed. For instance, when the at least one memory device 1016 is a hard drive, new content, new content options, new parameters, new settings for existing parameters, new settings for new parameters, new device drivers, and new communication protocols can be uploaded to the at least one memory device 1016 from the master controller 1012 or from some other external device. As another example, when the at least one memory device 1016 includes a CD/DVD drive including a CD/DVD configured to store content options, parameters, and settings, the software stored in the at least one memory device 1016 can be upgraded by replacing a first CD/DVD with a second CD/DVD. In yet another example, when the at least one memory device 1016 uses flash memory 1019 or EPROM 1008 units configured to store content, content options, parameters, and settings, the software stored in the flash and/or EPROM memory units can be upgraded by replacing one or more memory units with new memory units that include the upgraded software. In another embodiment, one or more of the memory devices, such as the hard drive, may be employed in a software download process from a remote software server.

In some embodiments, the at least one memory device 1016 also stores authentication and/or validation components 1044 configured to authenticate/validate specified EVCS 1000 components and/or information, such as hardware components, software components, firmware components, peripheral device components, user input device components, information received from one or more owner and/or user input devices, information stored in the at least one memory device 1016, etc.

In certain embodiments, the peripheral devices 1022 include several device interfaces, such as: (1) at least one output device 1020 including at least one display device 1035; (2) at least one input device 1030 (which may include contact and/or non-contact interfaces); (3) at least one transponder 1054; (4) at least one wireless communication component 1056; (5) at least one wired/wireless power distribution component 1058; (6) at least one sensor 1060; (7) at least one data preservation component 1062; (8) at least one motion/gesture analysis and interpretation component 1064; (9) at least one motion detection component 1066; (10) at least one portable power source 1068; (11) at least one geolocation module 1076; (12) at least one user identification module 1077; (13) at least one user/device tracking module 1078; and (14) at least one information filtering module 1079.

The at least one output device 1020 includes at least one display device 1035 configured to display any content displayed by the EVCS 1000 and any suitable information associated with such content. In certain embodiments, the display devices are connected to or mounted on a housing of the EVCS 1000 (described below). In various embodiments, the display devices serve as digital glass configured to advertise services and/or goods for purchase via the EVCS 1000 is located. In various embodiments, the display devices include, without limitation: a monitor, a television display, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display device includes a touch-screen with an associated touch-screen controller. The display devices may be of any suitable sizes, shapes, and configurations.

The display devices of the EVCS 1000 are configured to display one or more images, symbols, and indicia. In certain embodiments, the display devices of the EVCS 1000 are configured to display any suitable visual representation or exhibition of the movement of objects; dynamic lighting; video images; images of people, characters, places, things, and the like.

In various embodiments, the at least one output device 1020 includes a payout device. In one embodiment, the payout device is one or more of: (a) a ticket printer and dispenser configured to print and dispense a ticket or credit slip associated with a monetary value, wherein the ticket or credit slip may be redeemed for its monetary value via a cashier, a kiosk, or other suitable redemption system; (b) a bill dispenser configured to dispense paper currency; (c) a coin dispenser configured to dispense coins or tokens (such as into a coin payout tray); and (d) any suitable combination thereof.

In certain embodiments, rather than dispensing bills, coins, or a physical ticket having a monetary value to the user following receipt of an actuation of the cashout device, the payout device is configured to cause a payment to be provided to the user in the form of an electronic funds transfer, such as via a direct deposit into a bank account or a prepaid account of the user; via a transfer of funds onto an electronically recordable identification card or smart card of the user; or via sending a virtual ticket having a monetary value to an electronic device of the user.

In certain embodiments, the at least one output device 1020 is a sound generating device controlled by one or more sound cards. In one such embodiment, the sound generating device includes one or more speakers or other sound generating hardware and/or software configured to generate sounds, such as by playing music for any content or by playing music for other modes of the EVCS, such as an attract mode. In another such embodiment, the EVCS 1000 provides dynamic sounds coupled with attractive multimedia images displayed on one or more of the display devices to provide an audio-visual representation or to otherwise display full-motion video with sound to attract users to the EVCS 1000. In certain embodiments, the EVCS 1000 displays a sequence of audio and/or visual attraction messages during idle periods to attract potential users to the EVCS. The videos may be customized to provide any appropriate information.

The at least one input device 1030 may include any suitable device that enables an input signal to be produced and received by the at least one processor 1010 of the EVCS 1000.

In one embodiment, the at least one input device 1030 includes a payment device configured to communicate with the at least one processor of the EVCS 1000 to fund the EVCS 1000. In certain embodiments, the payment device includes one or more of: (a) a bill acceptor into which paper money is inserted to fund the EVCS 1000; (b) a ticket acceptor into which a ticket or a voucher is inserted to fund the EVCS 1000; (c) a coin slot into which coins or tokens are inserted to fund the EVCS 1000; (d) a reader or a validator for credit cards, debit cards, or credit slips into which a credit card, debit card, or credit slip is inserted to fund the EVCS 1000; (e) a user identification card reader into which a user identification card is inserted to fund the EVCS 1000; or (f) any suitable combination thereof. Some embodiments provide a combined bill and ticket acceptor 2128 and a coin slot 2126.

In one embodiment, the at least one input device 1030 includes a payment device configured to enable the EVCS 1000 to be funded via an electronic funds transfer, such as a transfer of funds from a bank account. In another embodiment, the EVCS 1000 includes a payment device configured to communicate with a mobile device of a user, such as a mobile phone, a radio frequency identification tag, or any other suitable wired or wireless device, to retrieve relevant information associated with that user to fund the EVCS 1000. When the EVCS 1000 is funded, the at least one processor determines the amount of funds entered and displays the corresponding amount on a credit display or any other suitable display as described below.

In various embodiments, the at least one input device 1030 includes a plurality of buttons that are programmable by the EVCS operator to, when actuated, cause the EVCS 1000 to perform particular functions. For instance, such buttons may be hard keys, programmable soft keys, or icons icon displayed on a display device of the EVCS 1000 (described below) that are actuatable via a touch screen of the EVCS 1000 or via use of a suitable input device of the EVCS 1000 (such as a mouse or a joystick).

In certain embodiments, the at least one input device 1030 includes a touch-screen coupled to a touch-screen controller or other touch-sensitive display overlay to enable interaction with any images displayed on a display device (as described below). One such input device is a conventional touch-screen button panel. The touch-screen and the touch-screen controller are connected to a video controller.

The at least one wireless communication component 1056 includes one or more communication interfaces having different architectures and utilizing a variety of protocols, such as (but not limited to) 802.11 (WiFi); 802.15 (including Bluetooth™); 802.16 (WiMax); 802.22; cellular standards such as CDMA, CDMA2000, and WCDMA; Radio Frequency (e.g., RFID); infrared; and Near Field Magnetic communication protocols. The at least one wireless communication component 1056 transmits electrical, electromagnetic, or optical signals that carry digital data streams or analog signals representing various types of information.

The at least one wired/wireless power distribution component 1058 includes components or devices that are configured to provide power to other devices. For example, in one embodiment, the at least one power distribution component 1058 includes a magnetic induction system that is configured to provide wireless power to one or more user input devices near the EVCS 1000. In one embodiment, an input device docking region is provided, and includes a power distribution component that is configured to recharge a user input device without requiring metal-to-metal contact. In one embodiment, the at least one power distribution component 1058 is configured to distribute power to one or more internal components of the EVCS, such as one or more rechargeable power sources (e.g., rechargeable batteries) located at the EVCS.

In certain embodiments, the at least one sensor 1060 includes at least one of: optical sensors, pressure sensors, RF sensors, infrared sensors, image sensors, thermal sensors, and biometric sensors. The at least one sensor 1060 may be used for a variety of functions, such as: detecting movements and/or gestures of various objects within a predetermined proximity to the EVCS 1000; detecting the presence and/or identity of various persons, devices, and/or systems within a predetermined proximity to the EVCS 1000.

The at least one data preservation component 1062 is configured to detect or sense one or more events and/or conditions that, for example, may result in damage to the EVCS 1000 and/or that may result in loss of information associated with the EVCS 1000. Additionally, the data preservation system 1062 may be operable to initiate one or more appropriate action(s) in response to the detection of such events/conditions.

The at least one motion/gesture analysis and interpretation component 1064 is configured to analyze and/or interpret information relating to detected user movements and/or gestures to determine appropriate user input information relating to the detected user movements and/or gestures. For example, in one embodiment, the at least one motion/gesture analysis and interpretation component 1064 is configured to perform one or more of the following functions: analyze the detected gross motion or gestures of a user; interpret the user's motion or gestures to identify instructions or input from the user; and/or utilize the interpreted instructions/input to provide additional functions may be implemented at a remote system or device.

The at least one geolocation module 1076 is configured to acquire geolocation information from one or more remote sources and use the acquired geolocation information to determine information relating to a relative and/or absolute position of the EVCS 1000. For example, in one implementation, the at least one geolocation module 1076 is configured to receive GPS signal information for use in determining the position or location of the EVCS 1000. In another implementation, the at least one geolocation module 1076 is configured to receive multiple wireless signals from multiple remote devices and use the signal information to compute position/location information.

The at least one user identification module 1077 is configured to determine the identity of the current user or current owner of the EVCS 1000. For example, in one embodiment, the current user is required to perform a login process at the EVCS 1000 in order to access one or more features. Alternatively, the EVCS 1000 is configured to automatically determine the identity of the current user based on one or more external signals, such as an RFID tag or badge worn by the current user and that provides a wireless signal to the EVCS 1000 that is used to determine the identity of the current user. In at least one embodiment, various security features are incorporated into the EVCS 1000 to prevent unauthorized users from accessing confidential or sensitive information.

The at least one information filtering module 1079 is configured to perform filtering (e.g., based on specified criteria) of selected information to be displayed at one or more displays 1035 of the EVCS 1000.

In various embodiments, the EVCS 1000 includes a plurality of communication ports configured to enable the at least one processor of the EGM to communicate with and to operate with external peripherals, such as: accelerometers, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, SCSI ports, solenoids, speakers, thumbsticks, ticket readers, touch screens, trackballs, touchpads, wheels, and wireless communication devices.

Devices storing information may utilize apparatuses or methods to detect and prevent tampering. For instance, information stored in a memory device may be encrypted to prevent its misuse. In addition, the memory device may be secured behind a locked door. Further, one or more sensors may be coupled to the memory device to detect tampering with the memory device and provide some record of the tampering. In yet another example, the memory device storing information might be designed to detect tampering attempts and clear or erase itself when an attempt at tampering has been detected.

Mass storage devices used in a general purpose computing devices typically enable code and data to be read from and written to the mass storage device. Though this level of security could be provided by software, systems that include mass storage devices include hardware level mass storage data protection circuitry that operates at the circuit level to monitor attempts to modify data on the mass storage device and will generate both software and hardware error triggers should a data modification be attempted without the proper electronic and physical enablers being present.

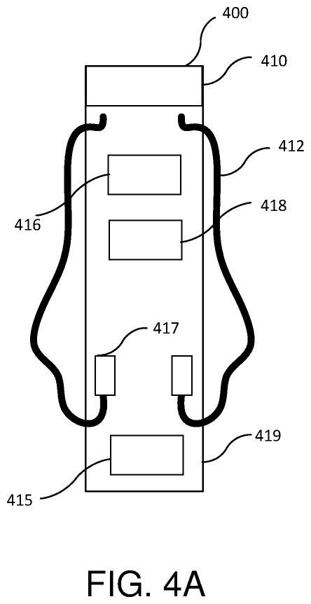

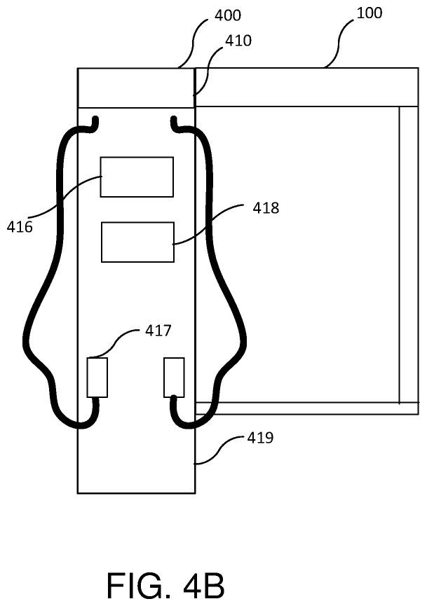

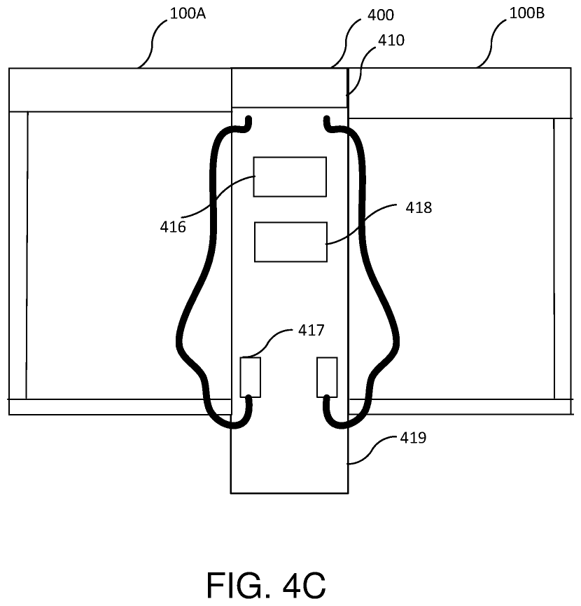

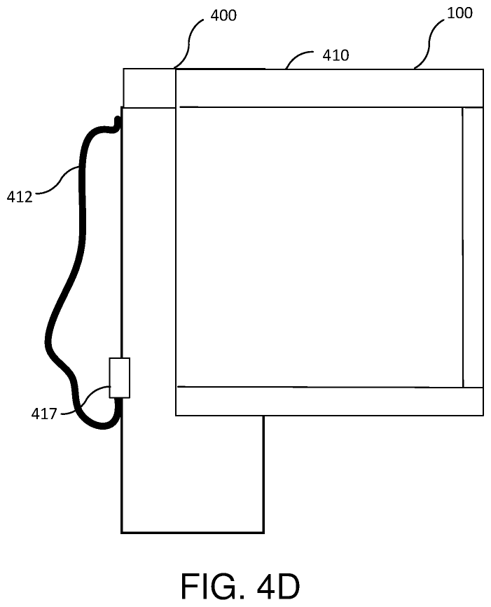

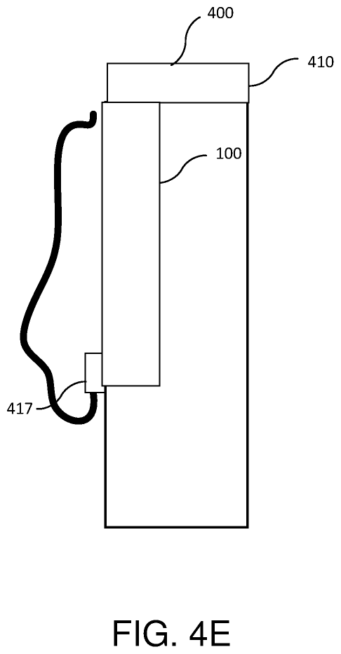

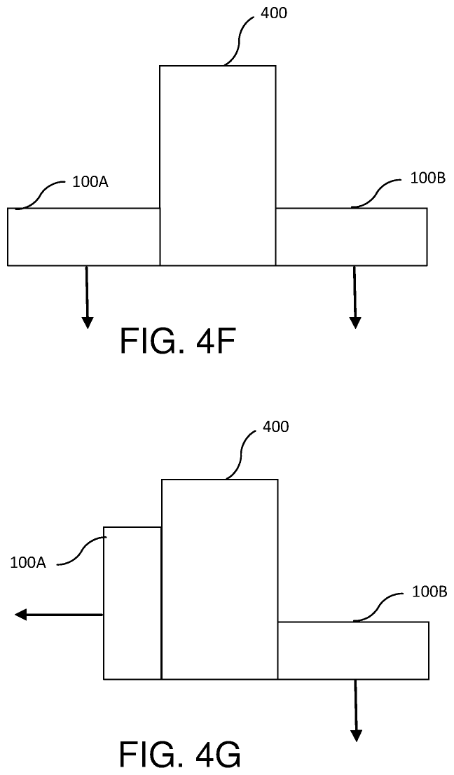

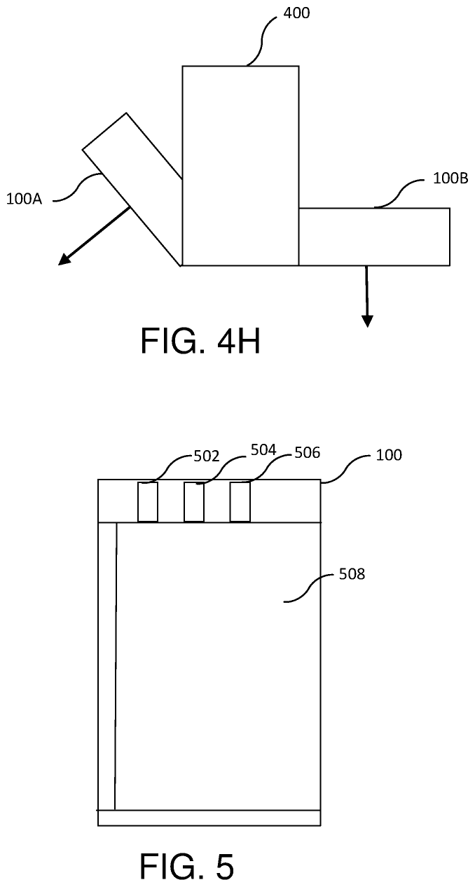

Reference is now made to FIGS. 4A-4G are schematic partial block diagrams illustrating hybrid EVCS embodiments disclosed herein. As illustrated, a hybrid electric vehicle charging station (EVCS) 400 includes a charging chassis 419 that is configured to support a charging circuitry 415 for providing a charge current to an electric vehicle. In some embodiments, the charging circuitry 415 is arranged within an interior that is defined by the charging chassis 419 while in other embodiments the charging circuitry 415 may be mounted external to the interior defined by the charging chassis 419.

In some embodiments, the EVCS 400 includes a multi-conductor cable 412 that is attached to the charging chassis 419 and that receives the charging current from the charging circuitry 415 and that transmits the charging current to the electric vehicle. Some embodiments include more than one multi-conductor cables 412 to provide more than one charging operation at the same time. Some embodiments provide that cable terminal plugs 417 that are configured to provide a conductive coupling of the multi-conductor cable 412 to the electric vehicle.

Briefly referring to FIG. 4B, which illustrates a front view of the EVCS 400, a user interface 100 may be attached to the charging chassis 419 and may be configured to provide digital content to a vehicle operator during a charging event of the electric vehicle. In some embodiments, the charging chassis 419 includes multiple user interface attachment structures 410 that are each configured to support the user interface 100. For example, the user interface 100 illustrated in FIG. 4B extends from the right side of the charging chassis 410 and includes a display front that faces the same direction as the front of the EVCS 400.

Referring back to FIG. 4A, the front of the charging chassis 419 may include a locking front panel 416 that provides secure access to the interior of the charging chassis 419. Additionally, the front of the charging chassis 419 may include a display 418 for interfacing with the EVCS 100 that may include a touchscreen interface.

In some embodiments, different ones of the user interface attachment structures 410 are each configured to position the user interface in a different location relative to the charging chassis 419. For example, different ones of the user interface attachment structures 410 are each configured to position the user interface 100 to face different respective directions.

Referring to FIG. 4C, some embodiments provide that the user interface 100 includes a first user interface 100A and a second user interface 100B. Some embodiments provide that the first user interface 100A is attachable to the charging chassis 419 at a first one of the user interface attachment structures 410 and the second user interface is attachable to the charging chassis at a second one of the user interface attachment structures 410.

For example, some embodiments provide that a first user interface attachment structure 410 is configured to attach the first user interface 100A to be on a first side of the charging chassis 419 and the second one of the user interface attachment structures 410 is configured to attach the second user interface 100B to be on a second side of the charging chassis 419 that is different from the first side of the charging chassis 419.

In some embodiments, the first one of the user interface attachment structures 410 is configured to attach the first user interface 100A to face a first direction. The second one of the user interface attachment structures 410 is configured to attach the second user interface 100B to face a second direction that is different from the first direction. For example, referring to FIG. 4D, which is a side view of the EVCS 400, the user interface 100 may extend along the side of the charging chassis 419 and display content in a direction that is not facing the front of the charging chassis 419. Although not visible from this view, embodiments may include a second user interface 100 that is on the opposite of the charging chassis 419 and faces the opposite direction relative to the user interface 100 that is illustrated therein.

Referring to FIG. 4E, which is a side view of the EVCS 400, the user interface 100 may be mounted to the side of the charging chassis and face the front of the EVCS 400.

In some embodiments, the multi-conductor cable 412 includes a first multi-conductor cable that is configured to provide a first charging current to a first electric vehicle and a second multi-conductor cable that is configured to provide a second charging current to a second electric vehicle. In some embodiments, the digital content includes first digital content at the first user interface and second digital content at the second user interface. Some embodiments provide that the first digital content is different from the second digital content, while other embodiments provide that the first and second digital content are the same and/or share a portion of common digital content.

Brief reference is made to FIGS. 4F-4H, which are top views of several respective embodiments disclosed herein. For example, FIG. 4F illustrates an EVCS 400 that includes first user interface 100A on a first side of the charging chassis 419 and a second user interface 100B on a second side of the charging chassis 419 that is opposite the first side of the charging circuitry. In this embodiment, each of the user interfaces 100A, 100B are facing the front as illustrated by the front facing arrows.

Referring to FIG. 4G, an EVCS 400 that includes first user interface 100A on a first side of the charging chassis 419 and a second user interface 100B on a second side of the charging chassis 419 that is opposite the first side of the charging chassis 419 s indicated by the side facing arrow. In this embodiment, the user interface 100A is arranged to be directed to the side of the charging chassis 419 while the user interface 100B is facing the front as illustrated by the front facing arrow.

In some embodiments, the user interfaces 100 may be configured to be facing a direction that is angularly between front and side configurations. For example, reference is made to FIG. 4H which illustrates that one of the user interfaces 100A faces angularly away from the charging chassis 419 and user interface 100B facing the front.

In some embodiments, the user interface 100 includes a display that is configured to provide video content to the electric vehicle operator. Reference is now made to FIG. 5, which is a schematic partial block diagram illustrating a user interface 100 according to some embodiments.

Some embodiments provide that the display includes a touchscreen 508 that is configure to receive an input corresponding to the digital content.

In some embodiments, the user interface 100 includes an image capture device 502 that is configured to generate image data corresponding to the vehicle operator. In some embodiments, the image capture device 502 is further configured to capture a digital data pattern that includes data content. Some embodiments provide that the digital data pattern includes at least one of a bar code and/or a QR code.

In some embodiments, the user interface 100 includes a terminal 504 for receiving a payment. Such terminal may include electric, magnetic, electromagnetic, optical, wireless and/or wired, among others. In some embodiments, the payment corresponds to payment for charging, payment for entertainment content, payment for a purchase of food, and/or payment for electric vehicle specific service.

Some embodiments provide that the user interface includes a microphone 506 that is configured to generate an audio content corresponding to voice or other audio communication by the vehicle operator.

In some embodiments, the user interface attachment structures 410 include one or more types of removable fasteners and for attaching the user interface 100 to the charging chassis 419. In some embodiments, the user interface 100 includes a wireless communication device that is configured to be communicatively coupled to a user mobile terminal.

In some embodiments, the charging chassis 419 comprises a housing that is configured to define an interior that includes the charging circuitry 415. In some embodiments, the digital content includes charging and/or vehicle data corresponding to an owner of the EVCS. Some embodiments provide that the user interface 100 is configured to interface with the charging circuitry 419.

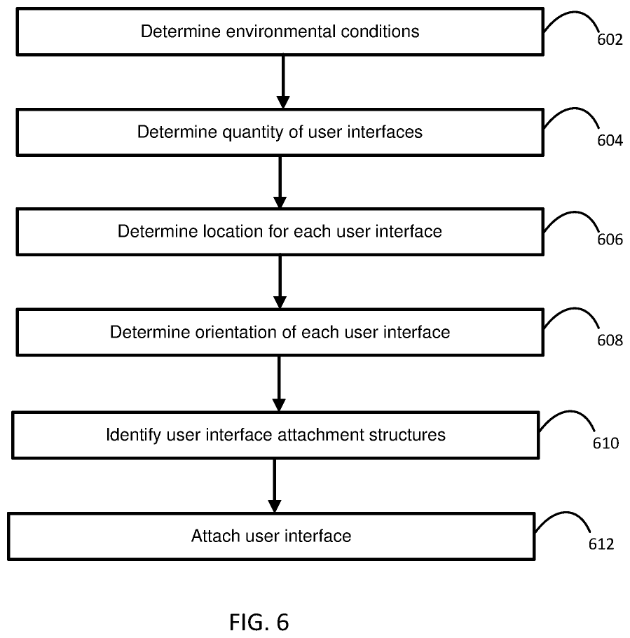

Reference is now made to FIG. 6, which is a flowchart illustrating operations of systems/methods according to some embodiments. According to some methods, operations may include determining (block 602) environmental conditions corresponding to a user interface installation on an EVCS at a desired location. Such environmental conditions may include but are not-limited to parking availability, traffic patterns, and/or structural encumbrances, among others. Operations include determining (block 604) a quantity of user interfaces that are compatible with the environmental conditions. For example, some environmental conditions may dictate how many user interfaces 100 may be installed on the EVCS 400.

Once it is determined how many user interfaces 100 may be used, operations include determining (block 606) a location corresponding to each of the quantity of user interfaces 100 and determining (block 608) an orientation corresponding to each of the user interfaces. Operations may include identifying (block 610) one or more user interface attachment structures 410 corresponding to the user interfaces 100 and attaching (block 612) the user interface 100 to the location and in the orientation on the EVCS.

Various changes and modifications to the present embodiments described herein will be apparent to those skilled in the art. Such changes and modifications can be made without departing from the spirit and scope of the present subject matter and without diminishing its intended technical scope. It is therefore intended that such changes and modifications be covered by the appended claims.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

What is claimed is:

1. A hybrid electric vehicle charging station (EVCS) comprising:
a charging chassis that is configured to support a charging circuitry for providing a charge current to an electric vehicle;
a multi-conductor cable that is attached to the charging chassis and that receives the charging current from the charging circuitry and that transmits the charging current to the electric vehicle; and
a user interface that is attached to the charging chassis and that is configured to provide digital content to a vehicle operator during a charging event of the electric vehicle,
wherein the charging chassis comprises a plurality of user interface attachment structures that are each configured to support the user interface.

2. The EVCS of claim 1, wherein different ones of the plurality of user interface attachment structures are each configured to position the user interface in a different location relative to the charging chassis.

3. The EVCS of claim 1, wherein different ones of the plurality of user interface attachment structures are each configured to position the user interface to face different respective directions.

4. The EVCS of claim 1, wherein the user interface comprises a first user interface and a second user interface, wherein the first user interface is attachable to the charging chassis at a first one of the plurality of user interface attachment structures and the second user interface is attachable to the charging chassis at a second one of the plurality of user interface attachment structure.

5. The EVCS of claim 4, wherein the first one of the plurality of user interface attachment structures is configured to attach the first user interface to face a first direction, and wherein the second one of the plurality of user interface attachment structures is configured to attach the second user interface to face a second direction that is different from the first direction.

6. The EVCS of claim 4, wherein the first one of the plurality of user interface attachment structures is configured to attach the first user interface to be on a first side of the charging chassis, and wherein the second one of the plurality of user interface attachment structures is configured to attach the second user interface to be on a second side of the charging chassis that is different from the first side of the charging chassis.

7. The EVCS of claim 4, wherein the multi-conductor cable comprises a first multi-conductor cable that is configured to provide a first charging current to a first electric vehicle and a second multi-conductor cable that is configured to provide a second charging current to a second electric vehicle,
wherein the digital content comprises first digital content at the first user interface and second digital content at the second user interface, and
wherein the first digital content is different from the second digital content.

8. The EVCS of claim 1, wherein the user interface comprises a display that is configured to provide video content to the electric vehicle operator.

9. The EVCS of claim 8, wherein the display comprises a touchscreen that is configure to receive an input corresponding to the digital content.

10. The EVCS of claim 1, wherein the user interface comprises an image capture device that is configured to generate image data corresponding to the vehicle operator.

11. The EVCS of claim 10, wherein the image capture device is further configured to capture a digital data pattern that comprises data content, and wherein the digital data pattern comprises at least one of a bar code and/or a QR code.

12. The EVCS of claim 1, wherein the user interface comprises a terminal for receiving a payment.

13. The EVCS of claim 12, wherein the payment corresponds to payment for charging, payment for entertainment content, payment for a purchase of food, and/or payment for electric vehicle specific service.

14. The EVCS of claim 1, wherein the plurality of user interface attachment structures comprise one or more types of removable fasteners and for attaching the user interface to the charging chassis.

15. The EVCS of claim 1, wherein the user interface comprises a microphone that is configured to generate an audio content corresponding to voice communication by the vehicle operator.

16. The EVCS of claim 1, wherein the user interface comprises a wireless communication device that is configured to be communicatively coupled to a user mobile terminal.

17. The EVCS of claim 1, wherein the charging chassis comprises a housing that is configured to define an interior that includes the charging circuitry.

18. The EVCS of claim 1, wherein the digital content comprises charging and/or vehicle data corresponding to an owner of the EVCS.

19. The EVCS of claim 1, wherein the user interface is configured to interface with the charging circuitry.

20. A method comprising:
determining environmental conditions corresponding to a user interface installation on an EVCS at a desired location;
determining a quantity of user interfaces that are compatible with the environmental conditions;
determining a location corresponding to each of the quantity of user interfaces;
determining an orientation corresponding to each of the plurality of user interfaces;
identifying a plurality of user interface attachment structures corresponding to the user interfaces; and
attaching the user interface to the location and in the orientation on the EVCS.
